(19) United States
(12) Patent Application Publication
(10) Pub. No.: US 2009/0019004 A1
(43) Pub. Date: Jan. 15, 2009

(54) Notifications in a geo-spatial social network

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/827,776

(22) Filed: Jul. 13, 2007

(51) Int. Cl. G06F 17/30; G06F 7/00; G06F 9/44

(52) U.S. Cl. 707/3; 707/102; 719/318; 707/E17.014; 707/E17.032

(57) ABSTRACT

A method, system and apparatus of notifications in a geo-spatial social network are disclosed. In one embodiment, a method includes generating a community network of user profiles, each user profile associated with a specific geographic location, generating a display view to include a three-dimensional map view embodied by the community network and a user profile represented at a location in the three-dimensional map view associated with the specific geographic location of the user profile, and upon an occurrence of an event, generating a notification associated with the user profile. The method may also include generating the notification upon the occurrence of an event including creating, updating, modifying, moving and/or deleting the user profile, adding a wiki profile associated with the user profile, modifying and/or adding content associated with the wiki profile. The method may further include generating the notification intended for a destination and generating types of notifications.

### FIELD OF TECHNOLOGY

This disclosure relates generally to the technical field of communications, and in one embodiment, to a method, system and apparatus of notifications in a geo-spatial social network.

### BACKGROUND

An individual may join a social network and create a new personal profile by providing user-related information. The user may amend an existing personal profile by adding, changing, or deleting information. The user may want to let friends or other parties know of the creation or amendment of the personal profile, and/or may individually contact each party to apprise them of the creation or the amendment. Individual contact, however, may be time-consuming and/or tedious.

In addition, the user may look up personal profiles of other users. The user, however, may not know when a new personal profile of another is added. The user may also not know when the personal profile of another is changed or deleted. The user may periodically check the personal profiles of others for such changes. Continuous checking of multiple personal profiles may be time-consuming and/or tedious.

### SUMMARY OF THE DISCLOSURE

A method, system and apparatus of notifications in a geo-spatial social network are disclosed. In one aspect, a method includes generating a community network of user profiles, each user profile associated with a specific geographic location, generating a display view to include a three-dimensional map view embodied by the community network and a user profile represented at a location in the three-dimensional map view associated with the specific geographic location of the user profile, and upon an occurrence of an event, generating a notification associated with the user profile.

The method may further include generating the notification upon the occurrence of an event including creating, updating, modifying, moving and/or deleting the user profile, adding a wiki profile, modifying, and/or adding content associated with the wiki profile. The method may also include generating the notification intended for a destination (e.g., may include a personal digital assistant, a computer, a telephone, a facsimile device, and/or a pager). In addition, the method may include generating types of notifications (e.g., may include a welcome notification associated with a newly claimed user profile, an endorsement notification associated with an endorsement, and/or a notification associated with an advertisement).

The method may further include associating a level of detail (e.g., high or low levels of detail) with a status (e.g., claimed or unclaimed status) of a particular user profile, searching at least a portion of the user profiles based on at least one search criterion (e.g., may include a geographic region, a religion, an ethnicity, an age, an age range, and an interest), and providing search results associated with the search criterion and based on the level of detail associated with the particular user profile. The low level of detail may be associated with the unclaimed status and the high level of detail may be associated with the claimed status. The method may also include automatically receiving, by at least one destination associated with at least one user profile, the notification.

In another aspect, a system includes a geo-spatial environment and a community network module of the geo-spatial environment, to include user profiles, each user profile to include a specific geographic location. The system also includes a notification generation module to generate, upon an occurrence of an event (e.g., may include create, update, modify and/or delete the user profile, add a wiki profile, modify and/or add content associated with the wiki profile) associated with at least one user profile, notifications (e.g., may include types of notifications selected from a group consisting of a welcome notification associated with a newly claimed user profile, an endorsement notification associated with an endorsement, and a notification associated with an advertisement) and a notification receipt module to receive, by at least one destination (e.g., may include a personal digital assistant, a computer, a telephone, a facsimile device, and/or a pager) associated with at least one user profile, at least one notification.

The system further includes a map module of the geo-spatial environment to include map data which serve as a basis to render a three-dimensional map view in the geo-spatial environment which identifies at least some physical structures having specific geographic locations, and a display module of the geo-spatial environment to generate a display view of the three-dimensional map view embodied by a community network and a user profile represented at a location in the three-dimensional map view associated with the specific geographic location of the user profile. The system may further include a search module of the geo-spatial environment to generate search criteria (e.g., may include a geographic region, religion, an ethnicity, an age, an age range, and an interest) and perform a search, based on at least one search criterion, of at least a portion of the user profiles.

The system may yet include a level module of the geo-spatial environment to determine a level of detail associated with a status (e.g., may include an unclaimed status and/or a claimed status) of a particular user profile and generate search results based on the level of detail and based on the search criterion. If the status of the particular user profile is an unclaimed status, the search results may include a specific number of user profiles associated with the search results, and if the status of the particular user profile is a claimed status, the search results may include identification of each user profile associated with the search results.

The system may also include a wiki profile module of the geo-spatial environment to generate in the display view, a wiki profile associated with a user profile and an append module of the geo-spatial environment to generate with the wiki profile, content associated with the wiki profile.

In yet another aspect, a geo-spatial environment includes a first instruction set to enable a community network, to include a map database associated with map data, a user database associated with user profiles, each user profile associated with a specific geographic location identifiable in the map data, and a notification database associated with notifications, each notification associated with a user profile and a second instruction set integrated with the first instruction set to generate upon an occurrence of an event associated with a user profile, a notification associated with the user profile.

The geo-spatial environment also includes a third instruction set integrated with the first instruction set and the second instruction set to display a three-dimensional map view embodied by the community network, the user profile (e.g., may be displayed at a location in the three-dimensional map view associated with the specific geographic location of the user profile), and simultaneously to represent other user profiles adjacent to the user profile in the three-dimensional map view.

The geo-spatial environment may further include a fourth instruction set to generate search criteria and identify in the three-dimensional map view, the user profiles that match at least one search criterion and a fifth instruction set to automatically receive, at a destination associated with a particular user profile, a notification.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial environment communicating with users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a block diagram illustrating generation of a display view associated with the notifications, according to one embodiment.

FIG. 5 is a block diagram representing flow of the notifications to destinations for view by the users, according to one embodiment.

FIG. 6 is a user interface view displaying user profile details associated with a user in the community network, according to one embodiment.

FIG. 7 is a user interface view displaying notification settings associated with the user profile in the geo-spatial environment, according to one embodiment.

FIG. 8 is a user interface view displaying a notification associated with a user profile of a user in the geo-spatial environment, according to one embodiment.

FIG. 9 is a user interface view displaying a search performed by the user of the geo-spatial environment, according to one embodiment.

FIG. 10A is a user interface view displaying search results associated with a search for an unclaimed user profile, according to one embodiment.

FIG. 10B is a user interface view displaying search results associated with a search for a claimed user profile, according to one embodiment.

FIG. 11 is a table view displaying details associated with the user profiles in the geo-spatial environment, according to one embodiment.

FIG. 12 is a diagrammatic system view of a data processing system in which any of the embodiments disclosed herein may be performed, according to one embodiment.

FIG. 13A is a process flow of generating the notifications associated with the user profiles in the geo-spatial environment, according to one embodiment.

FIG. 13B is a continuation of the process flow of FIG. 13A, showing additional processes, according to one embodiment.

Other features of the present embodiments will be apparent from the accompanying drawings and from the detailed description that follows.

### DETAILED DESCRIPTION

A method, system and apparatus of notifications in a geo-spatial social network are disclosed. In the following description, for the purposes of explanation, numerous specific details are set forth in order to provide a thorough understanding of the various embodiments. It will be evident, however, to one skilled in the art that the various embodiments may be practiced without these specific details.

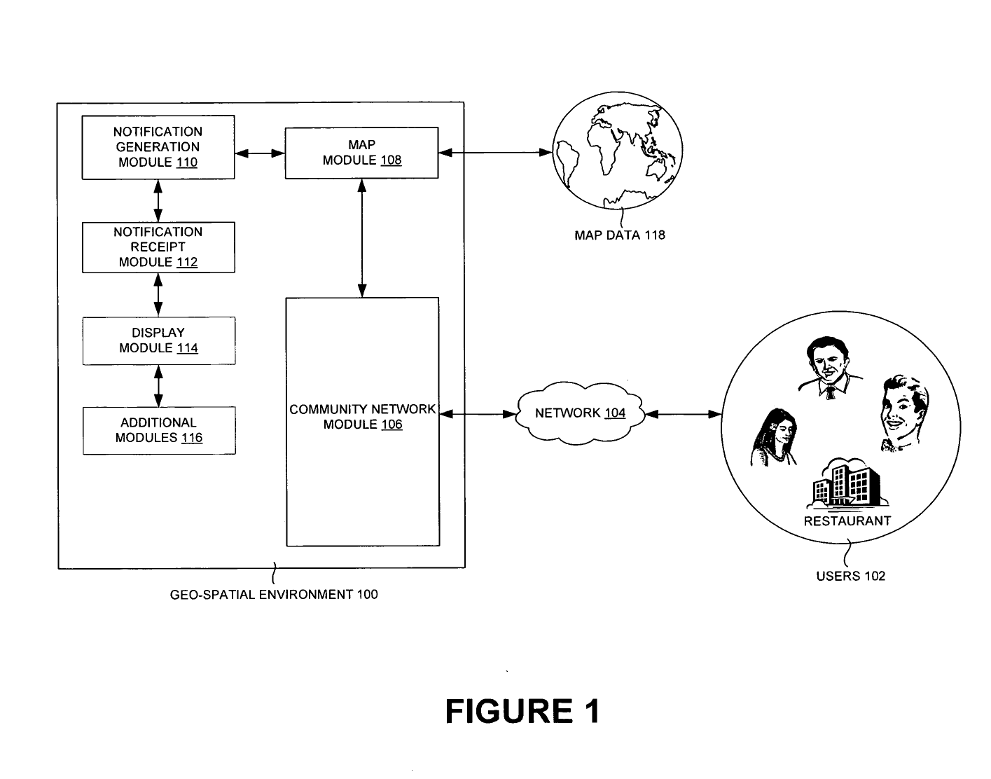

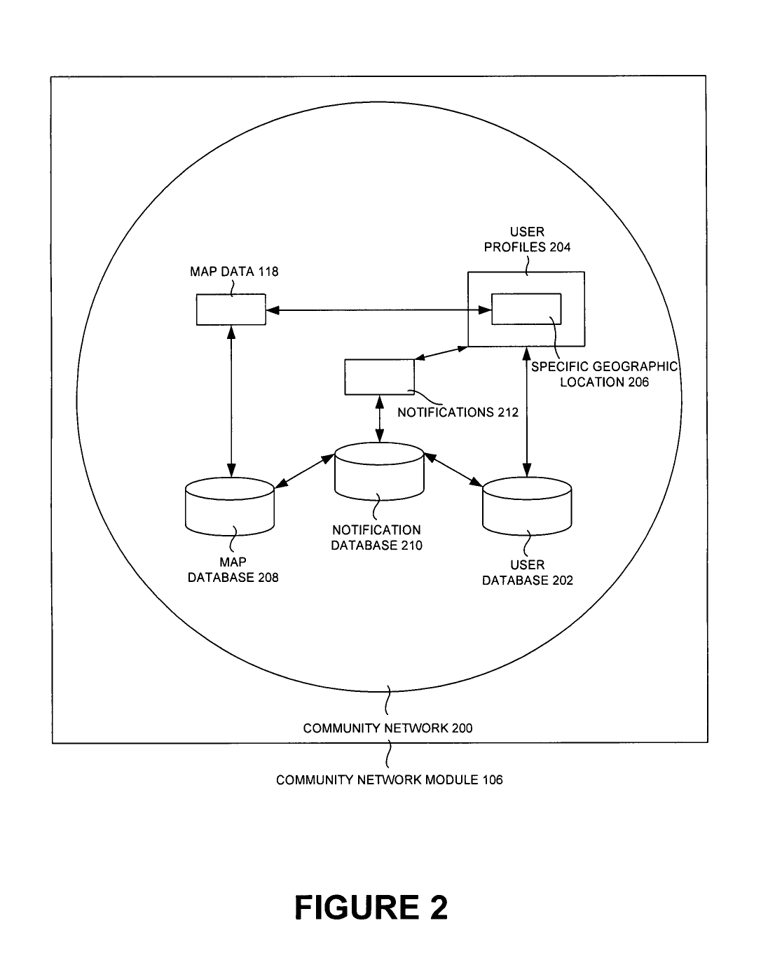

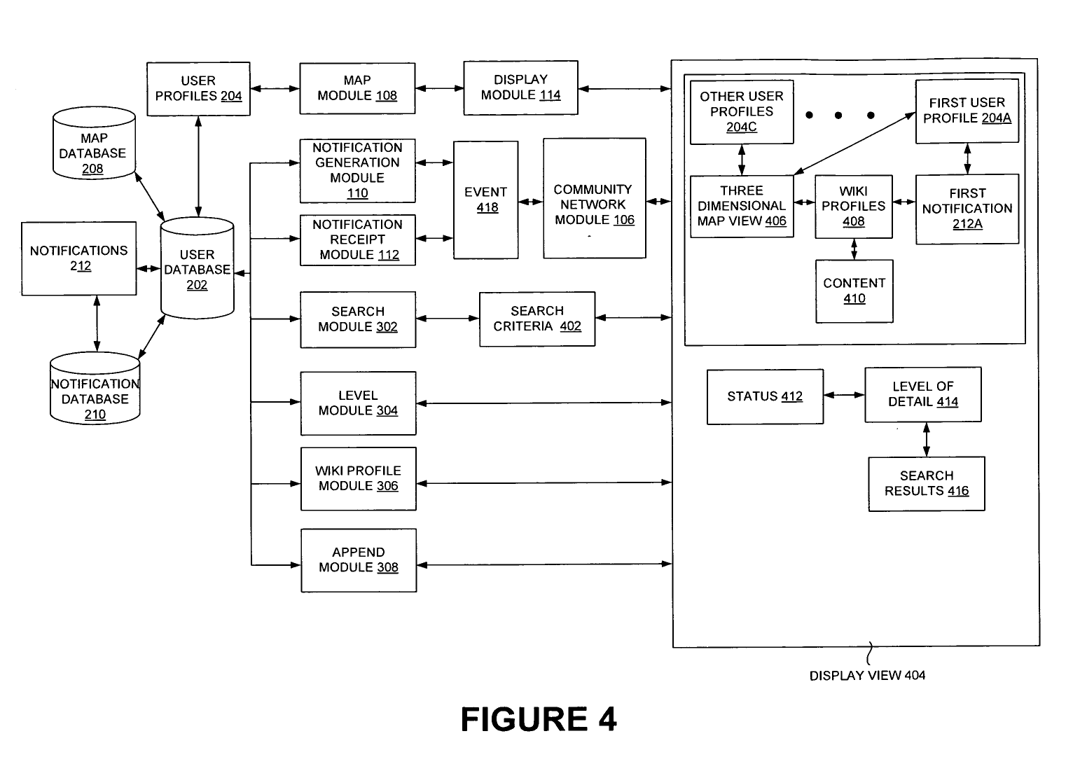

In one embodiment, a method includes generating a community network (e.g., the community network 200 of FIG. 2) of user profiles (e.g., the user profiles 204 of FIG. 2), each user profile 204 associated with a specific geographic location (e.g., the specific geographic location 206 of FIG. 2), generating a display view (e.g., the display view 404 of FIG. 4) to include a three-dimensional map view (e.g., the three-dimensional map view 406 of FIG. 4) embodied by the community network 200 (e.g., generated through the community network module 106 of FIG. 1) and a user profile 204 represented at a location in the three-dimensional map view 406 associated with the specific geographic location 206 of the user profile 204, and upon an occurrence of an event (e.g., the event 418 of FIG. 4), generating a notification (e.g., the notifications 212 of FIG. 2) associated with the user profile 204 (e.g., using the notification generation module 110 of FIG. 1).

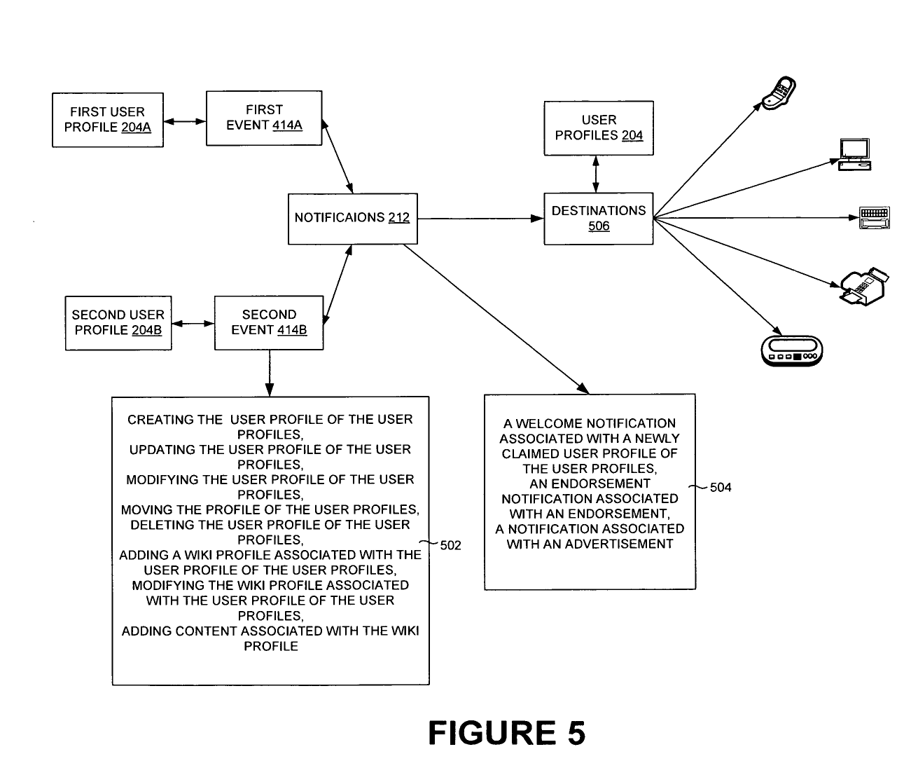

In another embodiment, a system includes a geo-spatial environment (e.g., the geo-spatial environment 100 of FIG. 1) and a community network module (e.g., the community network module 106 of FIG. 1) of the geo-spatial environment 100, to include user profiles (e.g., the user profiles 204 of FIG. 2), each user profile 204 to include a specific geographic location (e.g., the specific geographic location 206 of FIG. 2). The system also includes a notification generation module (e.g., the notification generation module 110 of FIG. 1) to generate, upon an occurrence of an event (e.g., the event 418 of FIG. 4) associated with a user profile 204, notifications (e.g., the notifications 212 of FIG. 2) and a notification receipt module (e.g., the notification receipt module 112 of FIG. 1) to receive, by a destination (e.g., the destinations 506 of FIG. 5) associated with a user profile 204, a notification 212.

The system further includes a map module (e.g., the map module 108 of FIG. 1) of the geo-spatial environment 100 to include map data (e.g., the map data 118 of FIG. 1) which serve as a basis to render a three-dimensional map view (e.g., the three-dimensional map view 406 of FIG. 4) in the geo-spatial environment 100 which identifies some physical structures having specific geographic locations 206, and a display module (e.g., the display module 114 of FIG. 1) of the geo-spatial environment 100 to generate a display view (e.g., the display view 404 of FIG. 4) of the three-dimensional map view 406 embodied by a community network (e.g., the community network 200 of FIG. 2) and a user profile 204 represented at a location in the three-dimensional map view 406 associated with the specific geographic location 206 of the user profile 204.

In yet another embodiment, a geo-spatial environment (e.g., the geo-spatial environment 100 of FIG. 1) includes a first instruction set to enable a community network (e.g., the community network 200 of FIG. 2), to include a map database (e.g., the map database 208 of FIG. 2) associated with map data (e.g., the map data 118 of FIG. 1), a user database (e.g., the user database 202 of FIG. 2) associated with user profiles (e.g., the user profiles 204 of FIG. 2), each user profile 204 associated with a specific geographic location (e.g., the specific geographic location 206 of FIG. 2) identifiable in the map data 118, and a notification database (e.g., the notification database 210 of FIG. 2) associated with notifications (e.g., the notifications 212 of FIG. 2), each notification 212 associated with a user profile 204.

The geo-spatial environment also includes a second instruction set integrated with the first instruction set to generate (e.g., using the notification generation module 110 of FIG. 1) upon an occurrence of an event (e.g., the event 418 of FIG. 4) associated with a user profile 204, a notification 212 associated with the user profile 204.

The geo-spatial environment further includes a third instruction set integrated with the first instruction set and the second instruction set to display (e.g., using the display module 114 of FIG. 1) a three-dimensional map view (e.g., the three-dimensional map view 406 of FIG. 4) embodied by the community network 200, the user profile 204 (e.g., may be displayed at a location in the three-dimensional map view 406 associated with the specific geographic location 206 of the user profile 204), and simultaneously to represent other user profiles (e.g., the other user profiles 204C of FIG. 4) adjacent to the user profile 204 in the three-dimensional map view 406.

FIG. 1 is a system view of a geo-spatial environment 100 communicating with users 102 through a network 104, according to one embodiment. Particularly, FIG. 1 illustrates the geo-spatial environment 100, the users 102, the network 104, a community network module 106, a map module 108, a notification generation module 110, a notification receipt module 112, a display module 114, additional modules 116 and map data 118, according to one embodiment.

The geo-spatial environment 100 may enable a community network (e.g., the community network 200 of FIG. 2) of user profiles (e.g., the user profile 204 of FIG. 2) where users 102 are notified of occurrence of any events (e.g., creating, updating, modifying, moving and/or deleting the user profile 204, adding a wiki profile 408, modifying, and/or adding content to the wiki profile 408, etc.) associated with the user profiles 204. For example, the community network 200 may be formed by the users 102 in the geo-spatial environment 100 to interact and/or communicate with each other. The users 102 may be entities (e.g., individuals, businesses, etc.) associated with the user profiles 204 of the community network 200 having specific geographic locations (e.g., the specific geographic location 206 of FIG. 2) in the geo-spatial environment 100.

The user profiles 204 may include name, address data, location data etc. of users 102 associated with specific geographic locations 206 in the geo-spatial environment 100. The network 104 may facilitate communication between the users 102 of the community network 200. The community network module 106 may generate the community network 200 that includes the user profiles 204 associated with the specific geographic location 206. For example, the users 102 of the geo-spatial environment 100 may form the community network 200 based on the specific geographic location 206 associated with their user profiles 204.

The map module 108 may generate a three dimensional map view (e.g., the three-dimensional map view 406 of FIG. 4) which includes physical structures having the specific geographic location 206 in the geo-spatial environment 100. For example, the physical structures may include businesses, residences and/or civic structures, etc. The notification generation module 110 may generate notifications (e.g., welcome notifications, endorsement notifications, etc.) upon the occurrence of events (e.g., the event 418 of FIG. 4) associated with the user profiles 204 in the community network 200. The notifications (e.g., the notifications 212 of FIG. 2) may be generated to inform the users 102 of the occurrence of events 418 associated with the user profiles 204 in the geo-spatial environment 100.

The notification receipt module 112 may facilitate receiving of the generated notifications 212 at destinations (e.g., the destinations 506 of FIG. 5) associated with the user profiles 204. For example, the destinations 506 may be personal devices of the users 102 that include a cell phone, a computer, a facsimile device and/or a pager. The display module 114 may display the user profiles 204 associated with the community network 200 in the three-dimensional map view 406.

The display module 114 may also display the generated notifications 212 in the three-dimensional map view 406. The additional modules 116 may consist of modules that generate additional processes associated with the community network 200. For example, the additional processes may include searching of desired user profiles, creating wiki profiles, adding contents to wiki profiles, etc. The map data 118 may serve as a basis to generate the three-dimensional map view 406 in the geo-spatial environment 100.

In the example embodiment illustrated in FIG. 1, the geo-spatial environment 100 communicates with the users 102 through the network 104. The geo-spatial environment 100 includes the community network module 106, the map module 108, the notification generation module 110, the notification receipt module 112, the display module 114 and the additional modules 116 that communicate with each other. The map module 108 also processes (e.g., generates, tracks, captures, stores and/or analyzes, etc.) the map data 118.

The notification 212 associated with the user profile 204 may be generated (e.g., using the notification generation module 110 of FIG. 1) upon the occurrence of an event 418. For example, the event 418 may include creating, updating, modifying, moving and/or deleting the user profile 204, adding a wiki profile (e.g., the wiki profiles 408 of FIG. 4), modifying, and/or adding content (e.g., the content 410 of FIG. 4) associated with the wiki profile 408, etc. The notification 212 may be automatically received (e.g., through the notification receipt module 112 of FIG. 1) by a destination (e.g., the destinations 506 of FIG. 5) associated with a user profile 204. The community network module 106 of the geo-spatial environment 100 may include the user profiles 204, each user profile 204 to include a specific geographic location 206. The notification generation module 110 may generate the notifications 212 (e.g., upon the occurrence of an event 418 including creating, updating, modifying, moving and/or deleting a user profile 204, adding a wiki profile, modifying and/or and adding content associated with the wiki profile, etc.) associated with the user profile 204.

The notification receipt module 112 may receive the notifications 212 (e.g., may include types of notifications selected from a group consisting of a welcome notification associated with a newly claimed user profile, an endorsement notification associated with an endorsement, and a notification associated with an advertisement) by the destination 506 (e.g., may include a personal digital assistant, a computer, a telephone, a facsimile device, and/or a pager) associated with the user profile 204. The map module 108 of the geo-spatial environment 100 may include the map data 118 which serve as a basis to render the three-dimensional map view 406 in the geo-spatial environment 100 which identifies the physical structures (e.g., businesses, residences, civic structures, etc.) having the specific geographic locations 206.

The display module 114 of the geo-spatial environment 100 may generate a display view (e.g., the display view 404 of FIG. 4) of the three-dimensional map view 406 embodied by the community network 200 and a user profile 204 represented at a location in the three-dimensional map view 406 associated with the specific geographic location 206 of the user profile 204. A second instruction set integrated with a first instruction set of the geo-spatial environment 100 may generate the notification 212 (e.g., using the notification generation module 110 of FIG. 1) associated with the user profile 204 upon the occurrence of an event 418 associated with the user profile 204 and a fifth instruction set of the geo-spatial environment 100 may automatically receive the notification 212 (e.g., through the notification receipt module 112 of FIG. 1) at a destination 506 associated with a particular user profile 204.

FIG. 2 is an exploded view of the community network module 106 of FIG. 1, according to one embodiment. Particularly, FIG. 2 illustrates the map data 118, a community network 200, a user database 202, user profiles 204, a specific geographic location 206, a map database 208, a notification database 210 and notifications 212, according to one embodiment.

The community network 200 may enable the users 102 to be informed about and updated with the occurrence of events 418 associated with the user profiles 204 in the geo-spatial environment 100 by generating the notifications 212. The user database 202 may generate the user profiles 204 associated with the community network 200. The user profiles 204 may be profiles generated from the user database 202 that are associated with the users 102 in the geo-spatial environment 100. The specific geographic location 206 may be a geographical location associated with the user profiles 204 in the geo-spatial environment 100. For example, the geographical locations associated with the user profiles 204 may be identified based on latitude and longitude.

The map database 208 may generate the map data 118 (e.g., address data and/or location data, etc.) that serve as the basis to render the three-dimensional map view 406. The notification database 210 may generate the notifications 212 upon the occurrence of events 418 associated with the user profiles 204 in the geo-spatial environment 100. The notifications 212 may refer to announcements, declaration, messages and/or statements that are generated in the geo-spatial environment 100 to inform the users 102 about the occurrence of events 418 associated with the user profiles 204. For example, a first notification (e.g., the first notification 212A of FIG. 4) associated with a first user profile (e.g., the first user profile 204A of FIG. 4) may be generated that is received at a destination of a second user profile (e.g., the second user profile 204B of FIG. 5) to inform the second user of any occurrence and/or happening of events 418 associated with the first user.

In the example embodiment illustrated in FIG. 2, the exploded view of the community network module 106 includes the community network 200. The community network 200 consists of the map data 118, the user database 202, the user profiles 204, the specific geographic location 206, the map database 208, the notification database 210 and the notifications 212 that communicate with each other. For example, the community network 200 of the user profiles 204 may be generated (e.g., using the community network module 106 of FIG. 1), each user profile 204 associated with a specific geographic location 206.

A first instruction set of the geo-spatial environment 100 may enable the community network 200, to include the map database 208 associated with the map data 118, the user database 202 associated with the user profiles 204 (e.g., each user profile 204 associated with a specific geographic location 206 identifiable in the map data 1118), and the notification database 210 associated with the notifications 212 (e.g., each notification 212 associated with a user profile 204).

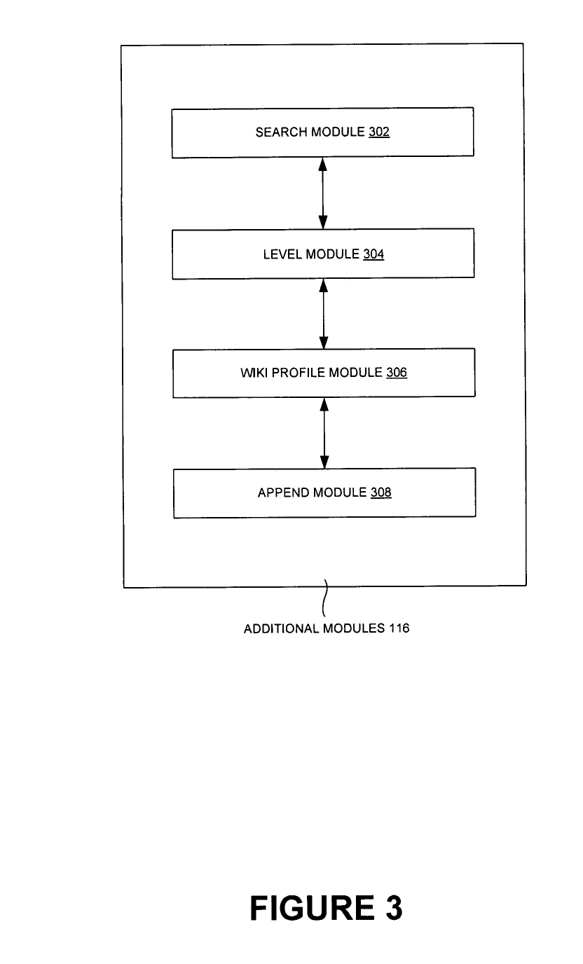

FIG. 3 is an exploded view of the additional modules 116 of FIG. 1, according to one embodiment. Particularly, FIG. 3 illustrates a search module 302, a level module 304, a wiki profile module 306 and an append module 308, according to one embodiment.

The search module 302 may generate search criteria (e.g., the search criteria 402 of FIG. 4) that enable the users 102 to perform a search of the user profiles 204 in the geo-spatial environment 100. For example, the users 102 may search to find newly claimed user profiles and/or updated user profiles associated with the community network 200 of the geo-spatial environment 100. The level module 304 may determine a level of detail (e.g., high level of detail, low level of detail, etc.) of a user profile 204 that is associated with a status 412 (e.g., claimed, unclaimed, etc.) of the user profile 204.

For example, the level of detail (e.g., the level of detail 414 of FIG. 4) may be rendered high when the user profile 204 is claimed and the level of detail 414 may remain low when the user profile 204 is unclaimed. The wiki profile module 306 may generate wiki profiles (e.g., the wiki profiles 408 of FIG. 4) associated with the user profiles 204 in the geo-spatial environment 100. The append module 308 may generate content (e.g., comments, feedback, remarks, etc.) added to the wiki profiles 408 by the users 102 of the geo-spatial environment 100.

In the example embodiment illustrated in FIG. 3, the additional modules 116 include the search module 302, the level module 304, the wiki profile module 306 and the append module 308, communicating with each other.

The search module 302 of the geo-spatial environment 100 may generate search criteria 402 (e.g., may include a geographic region, religion, an ethnicity, an age, an age range, and/or an interest) and perform a search of a portion of the user profiles 204 based on a search criterion 402. The level module 304 of the geo-spatial environment 100 may determine the level of detail 414 associated with the status 412 (e.g., may include an unclaimed status and/or a claimed status) of a particular user profile 204 and generate search results (e.g., the search results 416 of FIG. 4) based on the level of detail 414 and based on the search criterion 402. For example, if the status 412 of the particular user profile 204 is an unclaimed status, the search results 416 may include a specific number of user profiles 204 associated with the search results 416 and if the status of the particular user profile 204 is a claimed status, the search results 416 may include identification of each user profile 204 associated with the search results 416.

The wiki profile module 306 of the geo-spatial environment 100 may generate in the display view 404, a wiki profile 408 associated with a user profile 204 and the append module 308 of the geo-spatial environment 100 may generate with the wiki profile 408, the content 410 associated with the wiki profile 408.

FIG. 4 is a block diagram illustrating generation of a display view 404 associated with the notifications 212, according to one embodiment. Particularly, FIG. 4 illustrates the community network module 106, the map module 108, the notification generation module 110, the notification receipt module 112, the display module 114, the user database 202, the user profiles 204, a first user profile 204A, other user profiles 204C, the map database 208, the notification database 210, the notifications 212, a first notification 212A, the search module 302, the level module 304, the wiki profile module 306, the append module 308, a search criteria 402, the display view 404, a three-dimensional map view 406, wiki profiles 408, a content 410, a status 412, a level of detail 414, search results 416 and an event 418, according to one embodiment.

The search criteria 402 may serve as a tool based on which the users 102 perform search for desired user profiles (e.g., the user profiles 204 of FIG. 2) in the geo-spatial environment 100. The display view 404 may display the user profiles 204 in the three-dimensional map view 406 along with the generated notifications 212 associated with the user profiles 204. The three-dimensional map view 406 may enable the users 102 to visualize the user profiles 204 and the associated notifications 212.

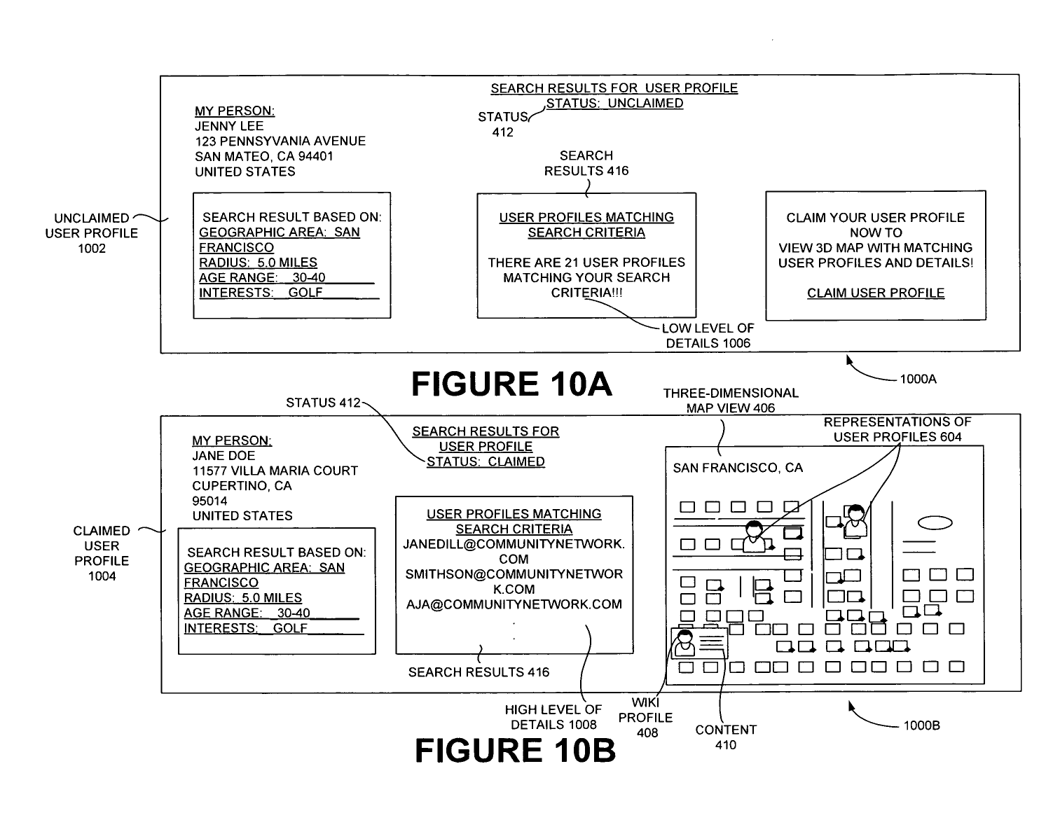

The wiki profiles 408 may be profiles (e.g., publicly editable profiles) associated with the users 102 that are displayed in the three-dimensional map view 406. The content 410 may be comments, remarks and/or feedbacks that are added to the wiki profiles 408 by the users 102 in the geo-spatial environment 100. The status 412 may refer to claimed and/or unclaimed status of the user profiles 204 in the community network 200. Claimed user profiles (e.g., the claimed user profile 1004 of FIG. 10B) may not be amended and/or modified by other users 102 of the geo-spatial environment 100 whereas unclaimed user profiles (e.g., the unclaimed user profile 1002 of FIG. 10A) may be publicly editable wiki profiles 408 that are edited by the other users 102 until a particular user claims a particular user profile 204.

The level of detail 414 may indicate a degree and extent of profile details the user 102 is willing to make public. The level of detail 414 may be associated with the status 412 (e.g., claimed status, unclaimed status, etc.) of the user profiles 204 in the geo-spatial environment 100. For example, the claimed user profile 1004 may have a high level of detail whereas the unclaimed user profile 1002 may have a low level of detail. The search results 416 may be results obtained when the users 102 perform the search for the desired user profiles 204 using the search criteria 402 in the geo-spatial environment 100. The event 418 may be actions (e.g., adding, deleting, modifying of user profiles 204, etc.) performed by the users 102, based on which the notifications 212 are generated in the geo-spatial environment 100.

In the example embodiment illustrated in FIG. 4, the display view 404 includes the three-dimensional map view 406, the wiki profiles 408 generated from the wiki profile module 306 and the content 410 generated from the append module 308. The display view 404 also shows the first user profile 204A, the other user profiles 204C that are generated from the user database 202. The search module 302 generates the search criteria 402 based on which the users 102 search for the desired user profiles 204.

The display view 404 also illustrates the first notification 212A associated with the first user profile 204A. The status 412, the level of detail 414 and the search results 416 associated with the user profiles 204 are also displayed in the display view 404. The level of detail 414 may be associated with the status 412 and the search results 416 may be displayed based on the level of detail 414 and the status 412 of the user profiles 204.

For example, the display view 404 may be generated to include the three-dimensional map view 406 embodied by the community network 200 and the user profile 204 represented at a location in the three-dimensional map view 406 associated with the specific geographic location 206 of the user profile 204. The level of detail 414 (e.g., may include a high level of detail, a low level of detail, etc.) may be associated with the status 412 (e.g., may include a claimed status, an unclaimed status, etc.) of the particular user profile 204.

A portion of the user profiles 204 may be searched (e.g., using the search module 302 of FIG. 3) based on the search criterion 402 (e.g., may include a geographic region, a religion, an ethnicity, an age, an age range, and/or an interest) and the search results 416 associated with the search criterion 402 and based on the level of detail 414 associated with the particular user profile 204 may be provided. The low level of detail may be associated with the unclaimed status and the high level of detail may be associated with the claimed status.

A third instruction set integrated with the first instruction set and the second instruction set of the geo-spatial environment 100 may display the three-dimensional map view 406 embodied by the community network 200, the user profile 204 (e.g., may be displayed at a location in the three-dimensional map view 406 associated with the specific geographic location 206 of the user profile 204), and may simultaneously represent other user profiles 204C adjacent to the user profile 204 in the three-dimensional map view 406. A fourth instruction set of the geo-spatial environment 100 may generate the search criteria 402 and identify in the three-dimensional map view 406, the user profiles 204 that match the search criterion 402.

FIG. 5 is a block diagram representing flow of the notifications 212 to destinations 506 for view by the users 102, according to one embodiment. Particularly, FIG. 5 illustrates the user profiles 204, the first user profile 204A, a second user profile 204B, the notifications 212, a first event 414A, a second event 414B, a block 502, a block 504 and destinations 506, according to one embodiment.

The block 502 may display the various events associated with the user profiles 204 based on which the notifications 212 are generated in the geo-spatial environment 100. The notifications 212 may be generated to inform other user profiles 204C about the occurrence of events 418 (e.g., associated with the user profiles 204) in the geo-spatial environment 100. The block 504 may represent the types of notifications that are generated in the geo-spatial environment 100. The types of notifications vary according to various events (e.g., a welcome notification when any user profile 204 is newly claimed, etc.). The destinations 506 may be targets where the generated notifications are intended to be received by the users 102 of the geo-spatial environment 100. The destinations may be personal communication devices that include a cell phone, a pager, a facsimile device and/or computer.

In the example embodiment illustrated in FIG. 5, the block 502 displays the second event 414B associated with the second user profile 204B that includes creating, updating, modifying, moving and deleting the user profiles 204. The block 502 also displays the events that include adding a wiki profile 408, modifying and adding content 410 to the wiki profile 408, based on which the notifications 212 may be generated to notify the other user profiles 204C of the geo-spatial environment 100. The block 504 displays the types of notifications 212 that include a welcome notification 212 associated with a newly claimed user profile 204, an endorsement notification 212 associated with an endorsement, and a notification 212 associated with an advertisement.

The notification 212 intended for the destination 506 (e.g., may include a personal digital assistant, a computer, a telephone, a facsimile device, and/or a pager) may be generated (e.g., using the notification generation module 110 of FIG. 1) and also the types of notifications (e.g., may include a welcome notification associated with a newly claimed user profile of the user profiles, an endorsement notification associated with an endorsement, and/or a notification associated with an advertisement) 212 may be generated (e.g., using the notification generation module 110 of FIG. 1).

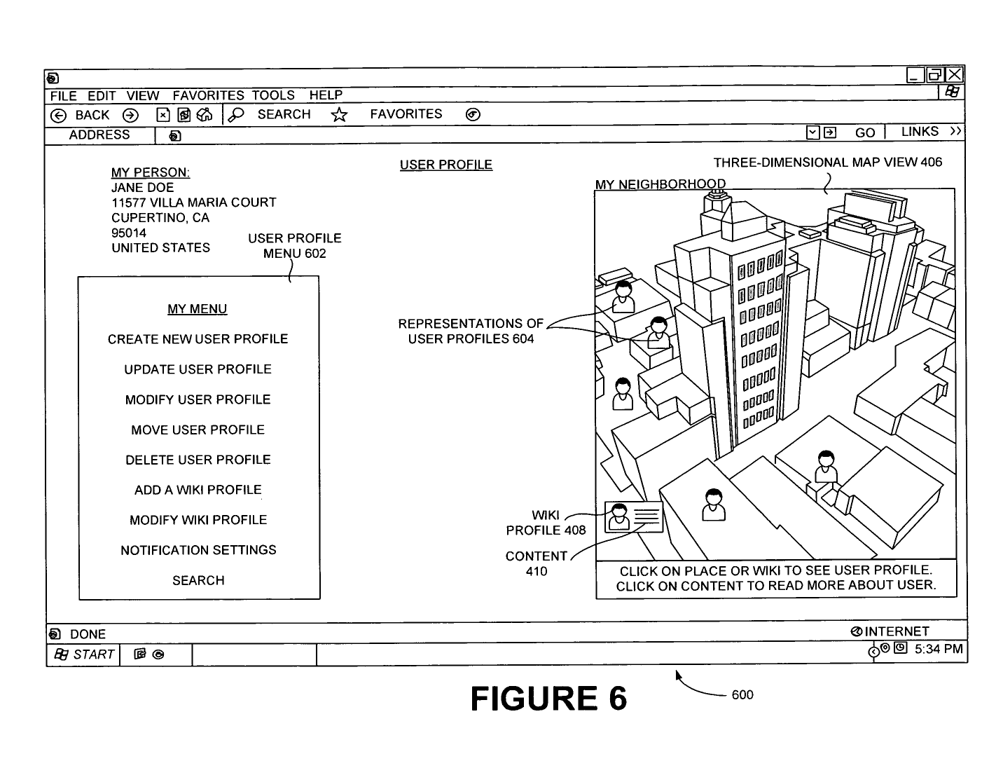

FIG. 6 is a user interface view 600 displaying user profile details associated with a user 102 in the community network 200, according to one embodiment. Particularly, FIG. 6 illustrates the three-dimensional map view 406, the wiki profile 408, the content 410, a user profile menu 602 and representations of user profiles 604, according to one embodiment.

The user profile menu 602 may display the events 418 associated with the user profiles 204 in the geo-spatial environment 100. The representations of user profiles 604 may be the user profiles 204 and wiki profiles 408 (e.g., publicly editable profiles) that are displayed in the three-dimensional map view 406.

In the example embodiment illustrated in FIG. 6, the user interface view 600 displays the profile details of the user (e.g., Jane Doe). The user profile menu 602 displays the events 418 that may occur in the geo-spatial environment 100, based on which the notifications 212 are generated. The events 418 include create new user profile 204, update, modify, move, delete user profile 204, add, modify wiki profile 408, etc.

The notification settings displayed in the user profile menu 602 allows the user to send and/or receive notifications 212 associated with the user profiles 204. The three-dimensional map view 406 displays neighborhood of the user (e.g., Jane Doe) where the user profiles 204 and the wiki profiles 408 are displayed. The content 410 may display more details associated with the users 102 in the geo-spatial environment 100.

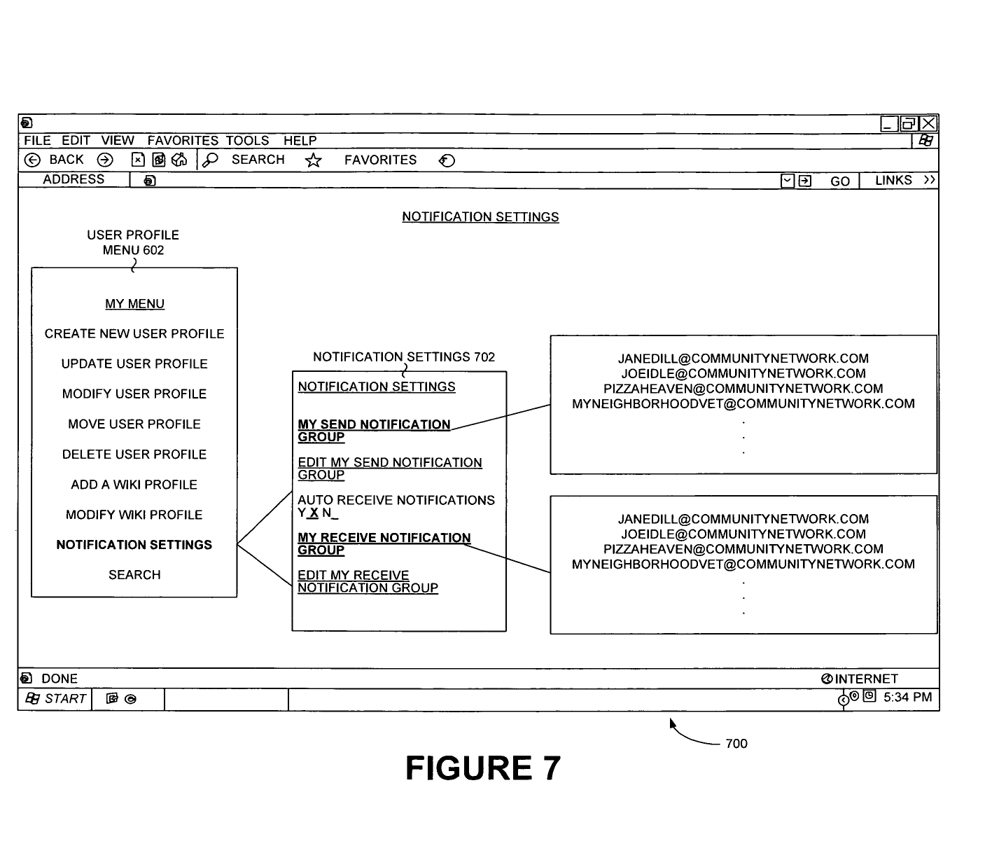

FIG. 7 is a user interface view 700 displaying the notification settings 702 associated with the user profile 204 in the geo-spatial environment 100, according to one embodiment. Particularly, FIG. 7 illustrates the user profile menu 602 and a notification settings option 702, according to one embodiment.

The notification settings option 702 may allow the users 102 of the geo-spatial environment 100 to send and/or receive the notifications 212 associated with the user profiles 204. For example, the notifications 212 may be sent to the users 102 of the geo-spatial environment 100 notifying them about the occurrence of events 418 associated with the user profiles 204.

In the example embodiment illustrated in FIG. 7, the user interface view 700 displays the notification settings option 702 that allow the users 102 to select groups of user profiles 204 that send and receive the notifications 212. The notifications 212 may be generated to inform the user profiles 204 about the occurrence and/or happenings of the events 418 associated with the other user profiles 204C in the geo-spatial environment 100. The notification 212 may be sent to the personal devices (e.g., computers, through e-mails, pager, cell phones, etc.) of the users 102 to keep them updated of the events 418 associated with the user profiles 204.

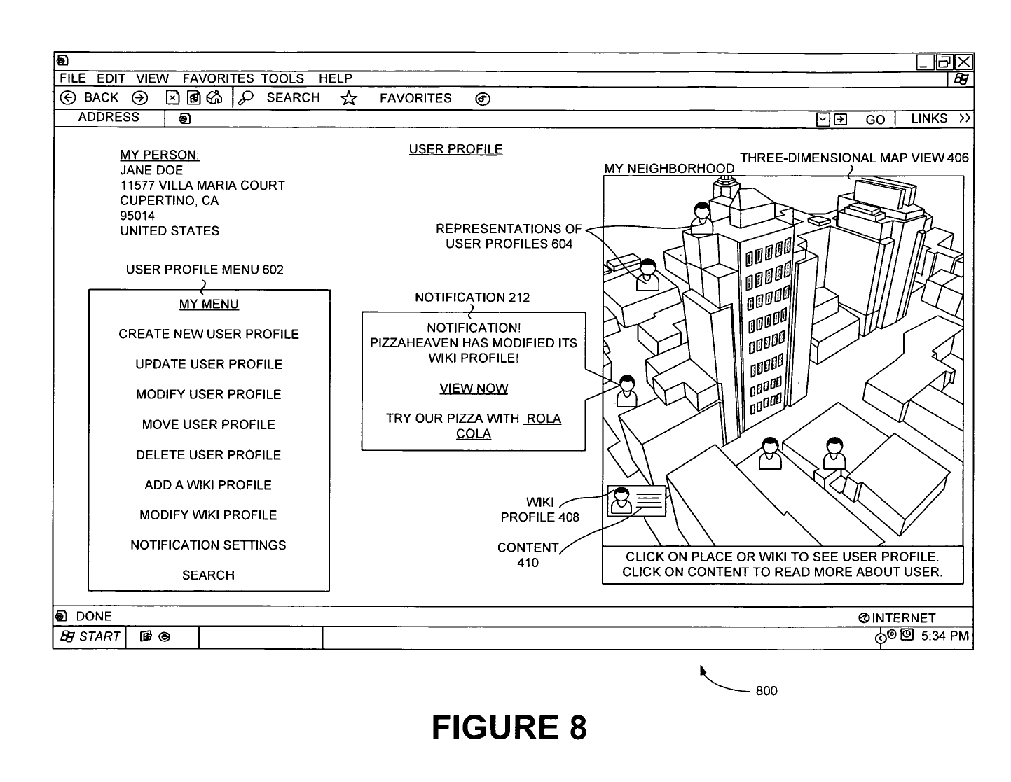

FIG. 8 is a user interface view 800 displaying a notification 212 associated with a user profile 204 of a user 102 in the geo-spatial environment 100, according to one embodiment. Particularly, FIG. 8 illustrates the notification 212, the three-dimensional map view 406, the wiki profile 408, the content 410, the user profile menu 602 and the representations of user profiles 604, according to one embodiment.

In the example embodiment illustrated in FIG. 8, the user interface view 800 displays the notification 212 (e.g., PizzaHeaven has modified its wiki profile), informing the users 102 of the geo-spatial environment 100 that the wiki profile 408 associated with PizzaHeaven has been modified. The users 102 may view the modified wiki profile 408 in the three-dimensional map view 406. The users 102 may add and/or modify the wiki profiles 408 using the content 410.

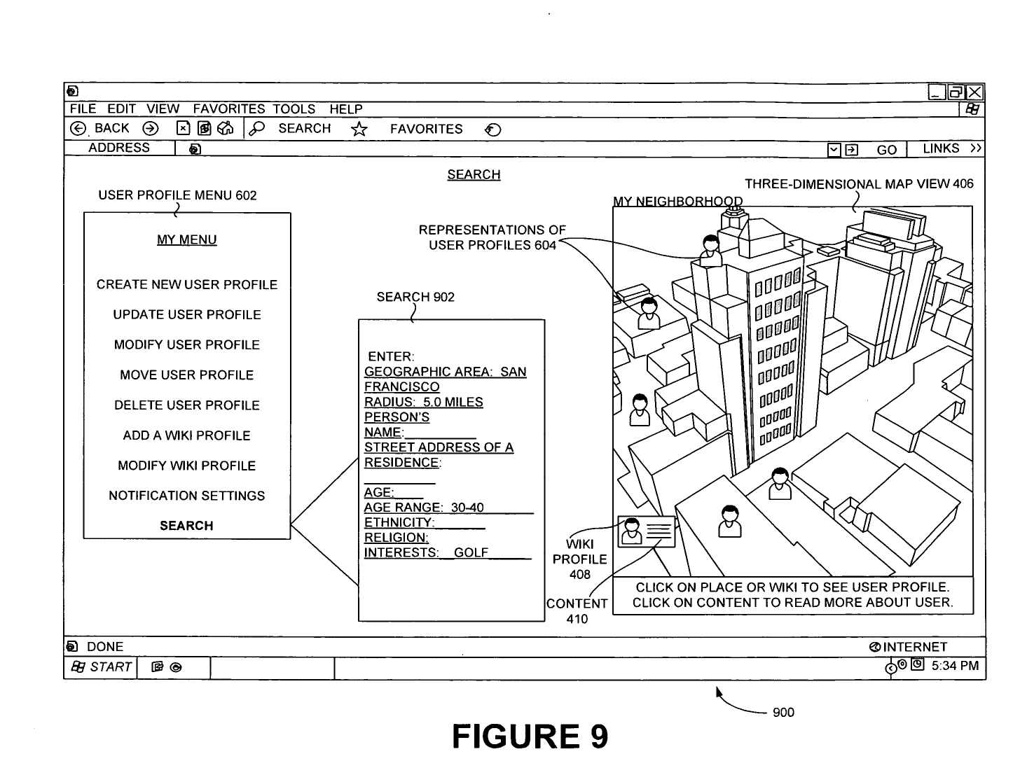

FIG. 9 is a user interface view 900 displaying a search performed by the user 102 of the geo-spatial environment 100, according to one embodiment. Particularly, FIG. 9 illustrates the three-dimensional map view 406, the wiki profile 408, the content 410, the user profile menu 602, the representations of user profiles 604 and a search option 902, according to one embodiment.

The search option 902 may enable the users 102 of the geo-spatial environment 100 to search for the desired user profiles 204 (e.g., newly created user profiles 204, modified user profiles 204, etc. in the geo-spatial environment 100).

In the example embodiment illustrated in FIG. 9, the user interface view 900 displays the search option 902 that enables the users 102 to visualize the desired user profiles 204 in the three-dimensional map view 406. The user interface view 900 provides the search criteria 402 that include geographic area, radius, person's name, street address, age, age range, ethnicity, religion, interest, etc. in the search option 902. The search results 416 may be obtained based on the search criteria 402 given by the users 102 in the search option 902.

FIG. 10A is a user interface view 1000A displaying search results 416 associated with a search for an unclaimed user profile 1002, according to one embodiment. Particularly, FIG. 10A illustrates the status 412, search results 416, an unclaimed user profile 1002 and low level of details 1006, according to one embodiment.

The unclaimed user profile 1002 may be a publicly editable user profile 204 that is not claimed by any users 102 in the geo-spatial environment 100. For example, the publicly editable profile may be a wiki profile 408 available for modification, deletion and/or updation by the users 102 of the geo-spatial environment 100. The low level of details 1006 may refer to details associated with the unclaimed user profile 1002. For example, when details associated with a user profile 204 are low, the user profile 204 may not be claimed by any users 102 in the geo-spatial environment 100.

In the example embodiment illustrated in FIG. 10A, the user interface view 1000A displays the search results 416 associated with the unclaimed user profile 1002. The details associated with the unclaimed user profile 1002 may be low and the search result 416 may include a specific number of user profiles 204 (e.g., 21 matching user profiles) matching the search criteria 402 provided.

FIG. 10B is a user interface view 1000B displaying search results 416 associated with a search for a claimed user profile 1004, according to one embodiment. Particularly, FIG. 10B illustrates the three-dimensional map view 406, the content 410, the status 412, the search results 416, the representations of user profiles 604, a claimed user profile 1004 and high level of details 1008, according to one embodiment.

The claimed user profile 1004 may be a user profile 204 that is claimed by a user 102 of the community network 200. The high level of details 1008 may be details associated with the claimed user profile 1004 in the geo-spatial environment 100.

In the example embodiment illustrated in FIG. 10B, the user interface view 1000B displays the search results 416 associated with the claimed user profile 1004. For example, when the user profile 204 is claimed, the level of detail associated with the user profile 204 may be high and the search results 416 may include identification of each user profile 204 in the geo-spatial environment 100. The user interface view 1000B also displays the three-dimensional map view 406 with the user profiles 204 and the content 410.

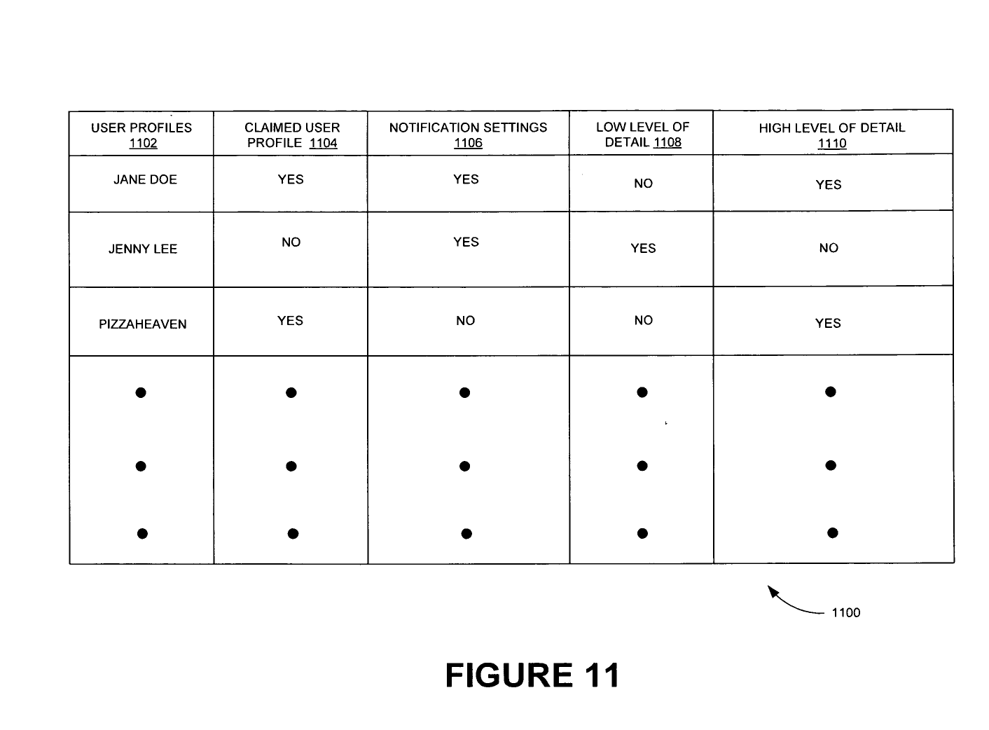

FIG. 11 is a table view 1100 displaying details associated with the user profiles 204 in the geo-spatial environment 100, according to one embodiment. Particularly, FIG. 11 illustrates a user profiles field 1102, a claimed user profile field 1104, a notification settings field 1106, a low level of detail field 1108 and a high level of detail field 1110, according to one embodiment.

The user profiles field 1102 may display an identifier (e.g., a name, a username, a unique key, etc.) associated with users 102 of the geo-spatial environment 100. The claimed user profile field 1104 may indicate whether the user profiles 204 are claimed or not in the geo-spatial environment 100. The notification settings field 1106 may display whether settings for notifying the other user profiles 204C of the events 418 associated with the user profiles 204 are available or not. The low level of detail field 1108 may indicate whether or not the level of profile details associated with the users 102 is low. The high level of detail field 1110 may indicate whether or not the level of profile details associated with the users 102 is high.

In the example embodiment illustrated in FIG. 11, the user profiles field 1102 displays “Jane Doe” in the first row, “Jenny Lee” in the second row and “Pizzaheaven” in the third row of the user profiles field column 1102. The claimed user profile field 1104 displays “Yes” in the first row, “No” in the second row and “Yes” in the third row of the claimed user profile field column 1104 (e.g., Jane Doe's user profile and Pizzaheaven's user profile are claimed while Jenny Lee's user profile is not claimed). The notification settings field 1106 displays “Yes” in the first row, “Yes” in the second row and “No” in the third row of the notification settings field column 1106 (e.g., Jane Doe and Jenny Lee have notification settings in their user profile menu 602 whereas Pizzaheaven has no notification settings in the user profile menu 602).

The low level of detail field 1108 displays “No” in the first row, “Yes” in the second row and “No” in the third row of the low level of detail field column 1108 (e.g., the level of user profile details associated with Jenny Lee is low). The high level of detail field 1110 displays “Yes” in the first row, “No” in the second row and “Yes” in the third row of the high level of detail field column 1110 (e.g., the level of profile details associated with Jane Doe and Pizzaheaven are high while Jenny Lee has a low level of profile details).

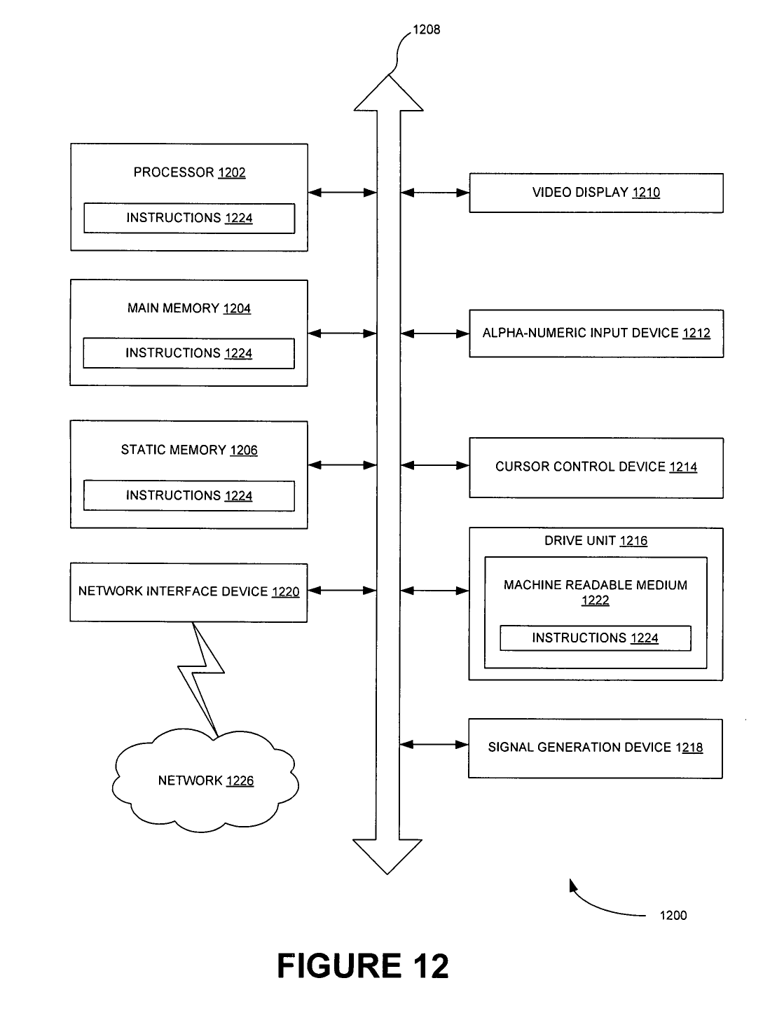

FIG. 12 is a diagrammatic system view 1200 of a data processing system in which any of the embodiments disclosed herein may be performed, according to one embodiment. Particularly, the diagrammatic system view 1200 of FIG. 12 illustrates a processor 1202, a main memory 1204, a static memory 1206, a bus 1208, a video display 1210, an alpha-numeric input device 1212, a cursor control device 1214, a drive unit 1216, a signal generation device 1218, a network interface device 1220, a machine readable medium 1222, instructions 1224 and a network 1226, according to one embodiment.

The diagrammatic system view 1200 may indicate a personal computer and/or the data processing system in which one or more operations disclosed herein are performed. The processor 1202 may be a microprocessor, a state machine, an application specific integrated circuit, a field programmable gate array, etc. (e.g., Intel® Pentium® processor). The main memory 1204 may be a dynamic random access memory and/or a primary memory of a computer system.

The static memory 1206 may be a hard drive, a flash drive, and/or other memory information associated with the data processing system. The bus 1208 may be an interconnection between various circuits and/or structures of the data processing system. The video display 1210 may provide graphical representation of information on the data processing system. The alpha-numeric input device 1212 may be a keypad, a keyboard and/or any other input device of text (e.g., a special device to aid the physically handicapped).

The cursor control device 1214 may be a pointing device such as a mouse. The drive unit 1216 may be the hard drive, a storage system, and/or other longer term storage subsystem. The signal generation device 1218 may be a bios and/or a functional operating system of the data processing system. The network interface device 1220 may be a device that performs interface functions such as code conversion, protocol conversion and/or buffering required for communication to and from the network 1226. The machine readable medium 1222 may provide instructions on which any of the methods disclosed herein may be performed. The instructions 1224 may provide source code and/or data code to the processor 1202 to enable any one or more operations disclosed herein.

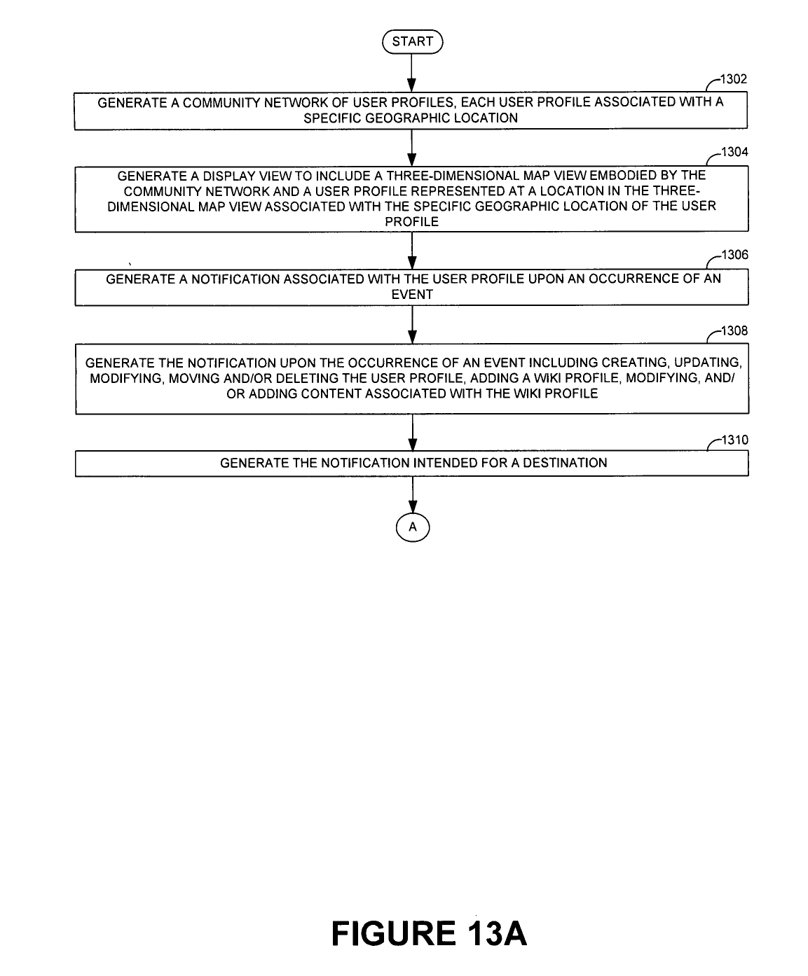

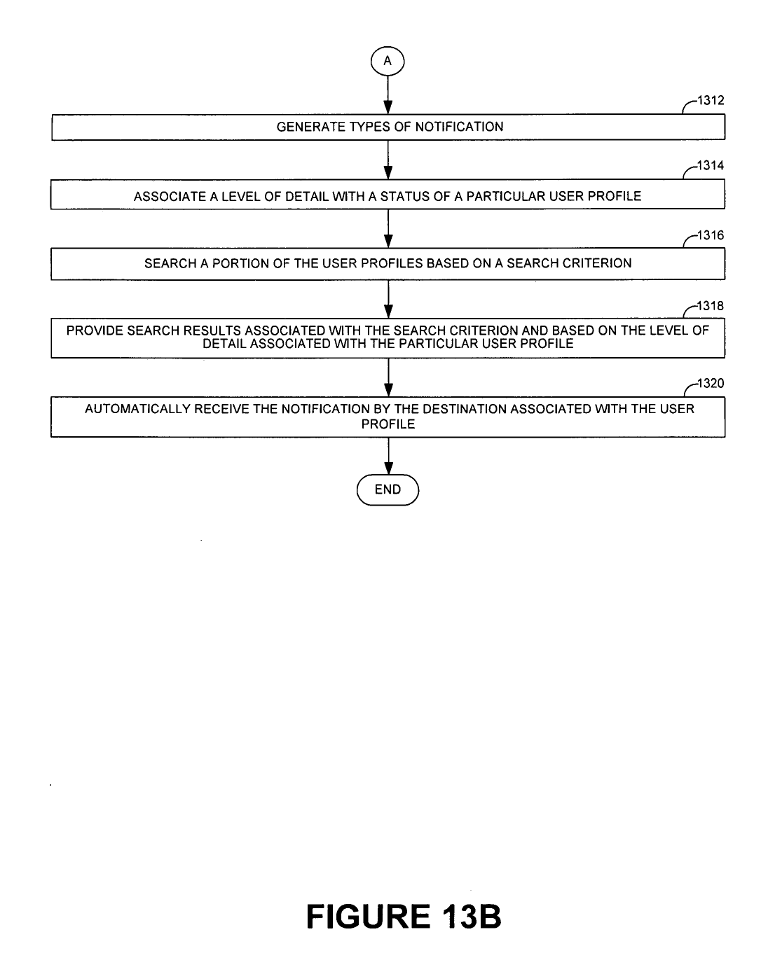

FIG. 13A is a process flow of generating notifications 212 associated with user profiles 204 in a geo-spatial environment (e.g., the geo-spatial environment 100 of FIG. 1), according to one embodiment. In operation 1302, a community network (e.g., the community network 200 of FIG. 2) of user profiles (e.g., the user profiles 204 of FIG. 2) may be generated (e.g., using the community network module 106 of FIG. 1), each user profile 204 associated with a specific geographic location (e.g., the specific geographic location 206 of FIG. 2). In operation 1304, a display view (e.g., the display view 404 of FIG. 4) may be generated (e.g., using the display module 114 of FIG. 1) to include a three-dimensional map view (e.g., the three-dimensional map view 406 of FIG. 4) embodied by the community network 200 and a user profile 204 represented at a location in the three-dimensional map view 406 associated with the specific geographic location 206 of the user profile 204.

In operation 1306, a notification (e.g., the notifications 212 of FIG. 2) associated with the user profile 204 may be generated (e.g., using the notification generation module 110 of FIG. 1) upon an occurrence of an event (e.g., the event 418 of FIG. 4). In operation 1308, the notification 212 may be generated upon the occurrence of an event 418 including creating, updating, modifying, moving and/or deleting the user profile 204, adding a wiki profile (e.g, the wiki profiles 408 of FIG. 4), modifying and/or adding content (e.g., the content 410 of FIG. 4) associated with the wiki profile 408. In operation 1310, the notification 212 intended for a destination (e.g., a personal digital assistant, a computer, a telephone, a facsimile device and/or a pager) may be generated.

FIG. 13B is a continuation of the process flow of FIG. 13A, showing additional processes, according to one embodiment. In operation 1312, types of notifications 212 may be generated. In operation 1314, a level of detail (e.g., the level of detail 414 of FIG. 4) may be associated with a status (e.g., the status 412 of FIG. 4) of a particular user profile 204. In operation 1316, a portion of the user profiles 204 may be searched based on a search criterion (e.g., the search criteria 402 of FIG. 4).

In operation 1318, search results (e.g., the search results 416 of FIG. 4) associated with the search criterion 402 and based on the level of detail 414 associated with the particular user profile 204 may be provided. In operation 1320, the notification 212 may be automatically received (e.g., using the notification receipt module 112 of FIG. 1) by the destination (e.g., the destinations 506 of FIG. 5) associated with a user profile 204.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structures and methods may be embodied using transistors, logic gates, and electrical circuits (e.g., Application Specific Integrated Circuitry (ASIC) and/or in Digital Signal Processor (DSP) circuitry).

For example, the community network module 106, the map module 108, the notification generation module 110, the notification receipt module 112, the display module 114, the additional modules 116, the search module 302, the level module 304, the wiki profile module 306, the append module 308 and other modules of FIGS. 1-13 may be enabled using a community network circuit, a map circuit, a notification generation circuit, a notification receipt circuit, a display circuit, additional circuits, a search circuit, a level circuit, a wiki profile circuit, an append circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating a community network of user profiles, each user profile of the user profiles associated with a specific geographic location;
generating a display view to include a three-dimensional map view embodied by the community network and a user profile of the user profiles represented at a location in the three-dimensional map view associated with the specific geographic location of the user profile of the user profiles; and
upon an occurrence of an event, generating a notification associated with the user profile of the user profiles.

2. The method of claim 1, further comprising generating the notification upon the occurrence of an event including at least one of creating the user profile of the user profiles, updating the user profile of the user profiles, modifying the user profile of the user profiles, moving the user profile of the user profiles, deleting the user profile of the user profiles, adding a wiki profile associated with the user profile of the user profiles, modifying the wiki profile associated with the user profile of the user profiles, and adding content associated with the wiki profile.

3. The method of claim 1, further comprising generating the notification intended for a destination.

4. The method of claim 3, wherein the destination includes at least one of a personal digital assistant, a computer, a telephone, a facsimile device, and a pager.

5. The method of claim 1, further comprising generating types of notifications.

6. The method of claim 5, wherein the types of notifications include at least one of a welcome notification associated with a newly claimed user profile of the user profiles, an endorsement notification associated with an endorsement, and a notification associated with an advertisement.

7. The method of claim 1, further comprising:
associating a level of detail with a status of a particular user profile of the user profiles;
searching at least a portion of the user profiles based on at least one search criterion; and
providing search results associated with the at least one search criterion and based on the level of detail associated with the particular user profile of the user profiles.

8. The method of claim 7, wherein the at least one search criterion includes a geographic region, a religion, an ethnicity, an age, an age range, and an interest.

9. The method of claim 7 wherein the level of detail includes at least one of a high level of detail and a low level of detail.

10. The method of claim 9 wherein the status of the particular profile includes at least one of a claimed status and an unclaimed status.

11. The method of claim 10, wherein the low level of detail is associated with the unclaimed status and the high level of detail is associated with the claimed status.

12. The method of claim 1, further comprising automatically receiving, by at least one destination associated with at least one user profile of the user profiles, the notification.

13. The method of claim 1 in a form of a machine-readable medium embodying a set of instructions that, when executed by a machine, causes the machine to perform the method of claim 1.

14. A system, comprising:
a geo-spatial environment;
a community network module of the geo-spatial environment, to include user profiles, each user profile of the user profiles to include a specific geographic location;
a notification generation module to generate, upon an occurrence of an event associated with at least one user profile of the user profiles, notifications;
a notification receipt module to receive, by at least one destination associated with at least one user profile of the user profiles, at least one notification of the notifications;
a map module of the geo-spatial environment to include map data which serve as a basis to render a three-dimensional map view in the geo-spatial environment which identifies at least some physical structures having specific geographic locations; and
a display module of the geo-spatial environment to generate a display view of the three-dimensional map view embodied by a community network and a user profile of the user profiles represented at a location in the three-dimensional map view associated with the specific geographic location of the user profile of the user profiles.

15. The system of claim 14, further comprising a search module of the geo-spatial environment to generate search criteria and perform a search, based on at least one search criterion of the search criteria, of at least a portion of the user profiles.

16. The system of claim 15, further comprising a level module of the geo-spatial environment to determine a level of detail associated with a status of a particular user profile of the user profiles and generate search results based on the level of detail and based on the at least one search criterion of the search criteria.

17. The system of claim 16, wherein the search criteria include a geographic region, religion, an ethnicity, an age, an age range, and an interest.

18. The system of claim 16, wherein the status includes at least one of an unclaimed status and a claimed status.

19. The system of claim 18, wherein:
if the status of the particular user profile of the user profiles is an unclaimed status, the search results include a specific number of user profiles associated with the search results; and
if the status of the particular user profile of the user profiles is a claimed status, the search results include identification of each user profile of the user profiles associated with the search results.

20. The system of claim 14, further comprising a wiki profile module of the geo-spatial environment to generate in the display view, a wiki profile associated with a user profile of the user profiles.

21. The system of claim 20, further comprising an append module of the geo-spatial environment to generate with the wiki profile, content associated with the wiki profile.

22. The system of claim 14, wherein the event includes at least one of create the user profile of the user profiles, update the user profile of the user profiles, modify the user profile of the user profiles, move the user profile of the user profiles, delete the user profile of the user profiles, add a wiki profile associated with the user profile of the user profiles, modify the wiki profile associated with the user profile of the user profiles, and add content associated with the wiki profile.

23. The system of claim 14, wherein the notification includes types of notifications selected from a group comprising a welcome notification associated with a newly claimed user profile of the user profiles, an endorsement notification associated with an endorsement, and a notification associated with an advertisement

24. The system of claim 14, wherein the destination includes at least one of a personal digital assistant, a computer, a telephone, a facsimile device, and a pager.

25. A geo-spatial environment, comprising:
a first instruction set to enable a community network, to include a map database associated with map data, a user database associated with user profiles, each user profile of the user profiles associated with a specific geographic location identifiable in the map data, and a notification database associated with notifications, each notification of the notifications associated with a user profile of the user profiles;
a second instruction set integrated with the first instruction set to generate upon an occurrence of an event associated with a user profile, a notification associated with the user profile of the user profiles; and
first instruction set and the second instruction set to display a three-dimensional map view embodied by the community network, the user profile of the user profiles, and simultaneously to represent other user profiles adjacent to the user profile of the user profiles in the three-dimensional map view, wherein the user profile of the user profiles is displayed at a location in the three-dimensional map view associated with the specific geographic location of the user profile.

26. The geo-spatial environment of claim 25, further comprising a fourth instruction set to generate search criteria and identify in the three-dimensional map view, the user profiles that match at least one search criterion of the search criteria.

27. The geo-spatial environment of claim 25, further comprising a fifth instruction set to automatically receive, at a destination associated with a particular user profile of the user profiles, a notification of the notifications.
